(19) United States
(12) Patent Application Publication
(10) Pub. No.: US 2018/0001348 A1
(43) Pub. Date: Jan. 4, 2018

(54) VIBRATING ACTUATOR

(71) Applicant: Nidec Copal Corporation, Tokyo (JP)

(72) Inventors: Shiori ISHII, Tokyo (JP); Noboru SEGAWA, Tokyo (JP); Yoshinori FUKASAKU, Tokyo (JP)

(73) Assignee: Nidec Copal Corporation, Tokyo (JP)

(21) Appl. No.: 15/543,351

(22) PCT Filed: Jan. 15, 2016
(86) PCT No.: PCT/JP2016/051097

§ 371 Date: Jul. 13, 2017

(30) Foreign Application Priority Data
Jan. 16, 2015 (JP) 2015-007249
Jan. 16, 2015 (JP) 2015-007250
Feb. 19, 2015 (JP) 2015-030898

(51) Int. Cl. B06B 1/04; H02K 33/02

(52) U.S. Cl. CPC B06B 1/045; H02K 33/02

(57) ABSTRACT

A vibration actuator having a plate-shaped body made from a magnetic material that has a planar supporting face; a movable element that vibrates in the axial direction along the supporting face, in direct contact, or partial contact through contacts, with a plurality of locations of the supporting face; an elastic member for elastically repelling the vibration of the movable element; and a coil, wherein a winding part is secured to the plate-shaped body, and is perpendicular, in relation to the axial direction, to a gap between the movable element and the plate-shaped body; wherein the movable element has a magnetic flux, which passes through the winding part of the coil, formed between the movable element and the plate-shaped body, and is provided with a magnet for magnetically attracting the movable element toward the supporting face side.

### CROSS-REFERENCE TO RELATED APPLICATIONS

This is a U.S. national phase application under 35 U.S.C. §371 of International Patent Application No. PCT/JP2016/051097, filed Jan. 15, 2016, and claims benefit of priority to Japanese Patent Application No. 2015-007249, filed Jan. 16, 2015; Japanese Patent Application No. 2015-007250, filed Jan. 16, 2015; and Japanese Patent Application No. 2015-030898, filed Feb. 19, 2015. The entire contents of these applications are hereby incorporated by reference.

### FIELD OF TECHNOLOGY

The present invention relates to a vibration actuator that causes a movable element to undergo reciprocating vibration through a signal input.

### BACKGROUND

A vibration actuator generates a vibration in accordance with a signal, such as an incoming call in a communication device, an alarm in any of a variety of electronic devices, or the like, to communicate, to the individual carrying the communication device, or to a user who is touching the electronic device, through a vibration, the state of the signal input, where such vibration motors are provided in a variety of electronic devices, such as in mobile information terminals.

Among the various forms of vibration actuators that are under development, there are known vibration actuators that are able to generate relatively large vibrations through reciprocating vibrations of a movable element. This type of conventional vibration actuator is provided with a weight and a magnet on a movable element side, where an electric current is applied to a coil that is provided on the stator side to cause the Lorentz forces that act on the magnet to form a driving force, to cause the movable element, which is elastically supported along the direction of vibration, to undergo reciprocating vibrations (referencing Japanese Patent Application No. 2011-97747).

### SUMMARY

Accompanying smaller and thinner mobile electronic devices, there are demands for further miniaturization and thickness reduction of vibration actuators that are used therein. In particular, in electronic devices that are provided with flat-panel display portions, such as smartphones, the space within the device in the direction of thickness, which is perpendicular to the display panel, is limited, and thus there is a strong need for the vibration actuator, which is equipped therein, to be thinner.

When attempting to reduce the thickness of a vibration actuator, one may consider achieving the desired driving force by securing an adequate magnet volume, and achieving the desired inertial force through ensuring an adequate mass in the weight, and achieving the reduction in thickness through forming into a flat shape the movable element that is provided with the magnet and the weight. In this case, if the movable element rolls (revolves) around the linear vibration axis, a movable element of a flat shape would be of a shape wherein the side portions that run along the direction of vibration would tend to strike the surrounding frame, which would produce a striking noise, interfering with achieving a stabilized operation. Because of this, in the prior art a stabilized linear vibration has been achieved through suppressing rolling of the movable element around the vibration axis through the provision of two guide shafts.

However, when two guide shafts are provided, not only does this increase the number of components, but it requires high accuracy in installation so that the two guide shafts will be disposed in parallel; there is thus a problem in that this causes the assembly operation to be complex.

Moreover, vibration actuators are installed not only in mobile electronic devices that are carried in a pocket of the clothing of the user, or placed in a briefcase or a handbag, such as a mobile telephone or a smartphone, but rather the scope of use thereof is expanding into wearable electronic devices that the user carries through wearing on the body.

With mobile electronic devices such as mobile telephones and smartphones, normally the use thereof is envisioned to be when held in the palm of one's hand, and these devices have thin box-shaped outer shapes that are easy to hold, and thus the vibration actuators that are installed therein are also equipped with box-shaped frames that have straight edges along a linear vibration track, to enable space-efficient storage within the box shape of the mobile electronic device.

In contrast, in mobile electronic devices, a variety of outer shapes are being considered in order to produce shapes that are more easily held, and when it comes to wearable electronic devices, there is research into a variety of shapes, such as wristwatch types (wristband types), eyeglass types, belt types (waistband types), necklace types, and the like, and thus when one considers installation into electronic devices of these shapes there is a problem in that a conventional box-shaped frame that has straight edges cannot be installed, with good spatial efficiency, into the electronic device.

In the present invention, the handling of such problems is an example of the problem to be solved. That is, the issues in the present invention is to provide a vibration actuator that can achieve a reduction in thickness in a vibration actuator through forming the movable element in a flat shape, that can produce a stabilized vibration in a movable element with a flat shape with a structure that reduces the number of components and that avoids complex assembly operations, and that can be installed, with good spatial efficiency in mobile electronic devices and wearable electronic devices with a variety of outer shapes.

In order to achieve such an object, the present invention is provided with the following structures:

A vibration actuator can have a plate-shaped body made from a magnetic material that has a flat supporting surface; a movable element that is in partial contact, either directly or through a contact piece, in a plurality of locations of the supporting surface, and that vibrates in an axial direction along the supporting surface; an elastic member for elastically repelling the vibration of the movable element; and a coil that is secured to the plate-shaped body, and wherein a coil part that is perpendicular to the axial direction is disposed in a space between the movable element and the plate-shaped body, wherein: the movable element comprises a magnet that forms a magnetic flux that passes through the coil part of the coil, between the movable element and the plate-shaped body, and that magnetically attracts the movable element toward the supporting surface side.

A vibration actuator includes a plate-shaped body made from a magnetic material that has a flat supporting surface; a movable element that is in partial contact, either directly or through a contact piece, in a plurality of locations of the supporting surface, and that vibrates in an axial direction along the supporting surface; an elastic member for elastically repelling the vibration of the movable element; and a coil that is secured to the plate-shaped body, and wherein a coil part that is perpendicular to the axial direction is disposed in a space between the movable element and the plate-shaped body, wherein: the movable element comprises a magnet; and the magnet is disposed facing a coil part of the coil, and has one magnet piece that has a direction of magnetization that is perpendicular to the supporting surface, and another magnet piece that forms a magnetic field that is deflected to the supporting surface side.

A vibration actuator has a supporting plate having an outer shape edge that is curved, and a guiding portion, in an inner surface, that has a vibration track along the outer shape edge; a movable element that undergoes reciprocating vibration along the vibration track, guided by the guiding portion, through being biased toward the inner surface side; a driving portion for causing the movable element to undergo reciprocating vibration along the inner surface; and an elastic member for supporting elastically the reciprocating vibration of the movable element.

The present invention, having distinctive features such as set forth above, enables a movable element with a flat shape to be vibrated stably with a structure that reduces the number of components and that avoids complex assembly through a vibration actuator that has the distinctive features described above. Moreover, the end edge of the outer shape of the supporting plate is bent to conform to the outer shape of a mobile electronic device or a wearable electronic device in which it is installed, enabling installation, with good spatial efficiency, into mobile electronic devices and wearable electronic devices of a variety of outer shapes.

### BRIEF DESCRIPTIONS OF THE DRAWINGS

FIG. 1 is an assembly perspective diagram illustrating the overall structure of a vibration actuator according to an embodiment according to the present invention.

FIG. 2 is an explanatory diagram illustrating the overall structure of a vibration actuator according to an embodiment according to the present invention (wherein (a) is a plan view and (b) is a cross-sectional diagram along the section A-A).

FIG. 3 is an explanatory diagram illustrating a vibration actuator according to an embodiment according to the present invention (a cross-sectional diagram along the section B-B in FIG. 2 (a)).

FIG. 4 is an assembly perspective diagram illustrating the overall structure of a vibration actuator according to another embodiment according to the present invention.

FIG. 5 is a plan view illustrating the internal structure of a vibration actuator according to another embodiment according to the present invention.

FIG. 6 is an explanatory diagram illustrating the overall structure of a vibration actuator according to another embodiment according to the present invention (wherein (a) is a plan view and (b) is a cross-sectional diagram along the section A-A).

FIG. 7 is an explanatory diagram illustrating a vibration actuator according to another embodiment according to the present invention (a cross-sectional diagram along the section B-B in FIG. 2 (a)).

FIG. 8 is an external perspective diagram of a vibration actuator according to an embodiment according to the present invention.

FIG. 9 is an explanatory diagram illustrating a mobile electronic device (a mobile information terminal) in which is provided a vibration actuator according to an embodiment according to the present invention.

FIG. 10 is an explanatory diagram illustrating the overall structure of a vibration actuator according to another embodiment according to the present invention (wherein (a) is a plan view, (b) is a side view, and (c) is a cross-sectional diagram along the section X-X in (b)).

FIG. 11 is an assembly perspective diagram (a downward view) of a vibration actuator according to another embodiment according to the present invention.

FIG. 12 is an assembly perspective diagram (an upward view) of a vibration actuator according to another embodiment according to the present invention.

FIG. 13 is an explanatory diagram illustrating an external view (in the installed state) of a vibration actuator according to another embodiment according to the present invention.

FIG. 14 is an explanatory diagram illustrating the overall structure of a vibration actuator according to another embodiment according to the present invention (wherein (a) is a plan view, (b) is a side view, and (c) is a cross-sectional diagram along the section X-X in (a)).

FIG. 15 is an assembly perspective diagram (a downward view) of a vibration actuator according to another embodiment according to the present invention.

FIG. 16 is an assembly perspective diagram (an upward view) of a vibration actuator according to another embodiment according to the present invention.

FIG. 17 is an explanatory diagram illustrating an external view (in the installed state) of a vibration actuator according to another embodiment according to the present invention.

FIG. 18 is electronic devices equipped with vibration actuators according to embodiments according to the present invention (wherein (a) is a disk-shaped mobile electronic device, (b) is a wristband-type wearable electronic device, and (c) is an eyeglass-type wearable electronic device).

### DETAILED DESCRIPTION

Embodiments according to the present invention will be explained below in reference to the drawings. In the drawings below, locations that are depicted identically in the various drawings are assigned identical reference symbols, and redundant explanations are omitted. In the drawings, the direction of vibration (the axial direction) is defined as the X axial direction, and the directions perpendicular thereto are defined as the Y axial direction (the width direction) and the Z axial direction (the height direction).

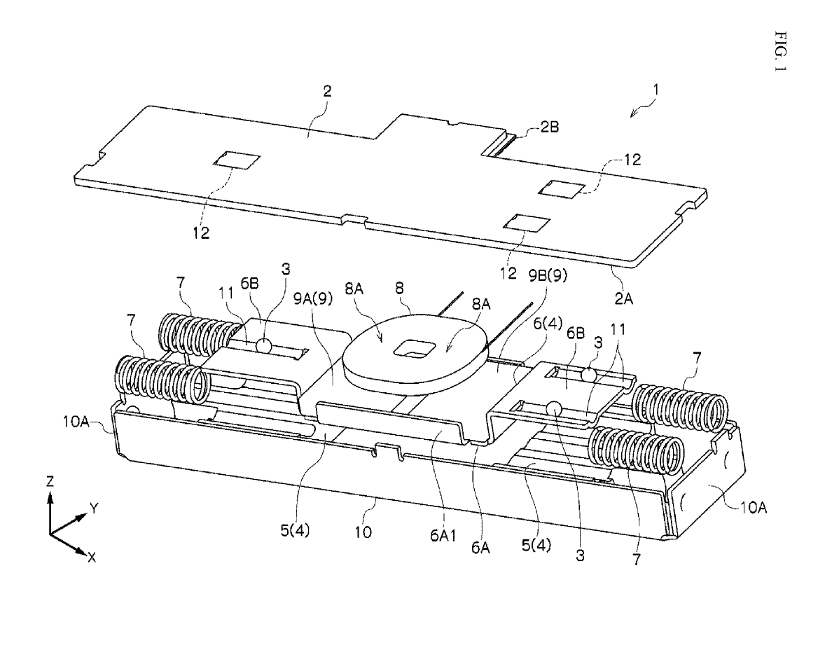

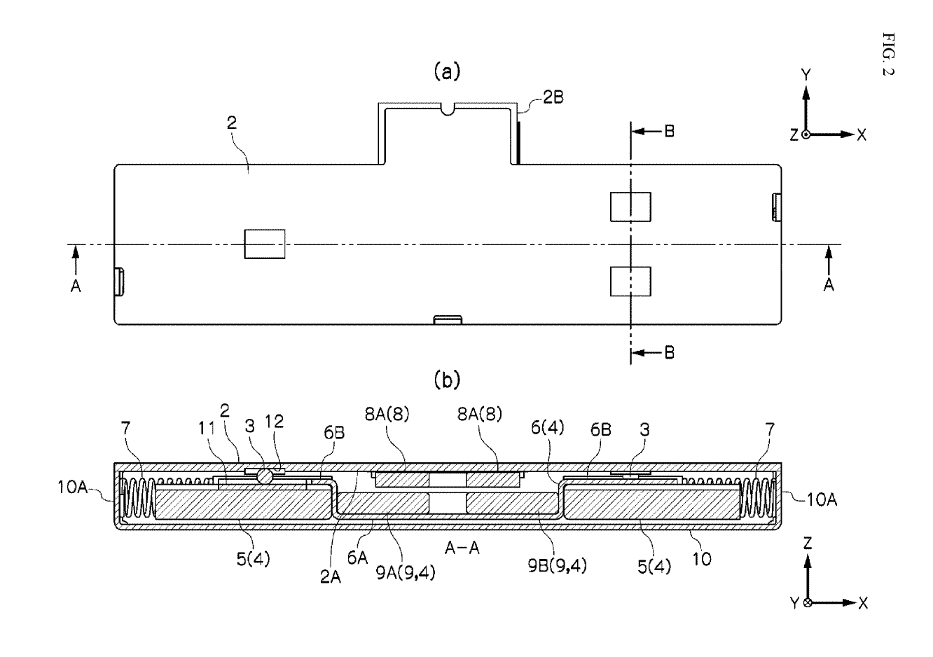

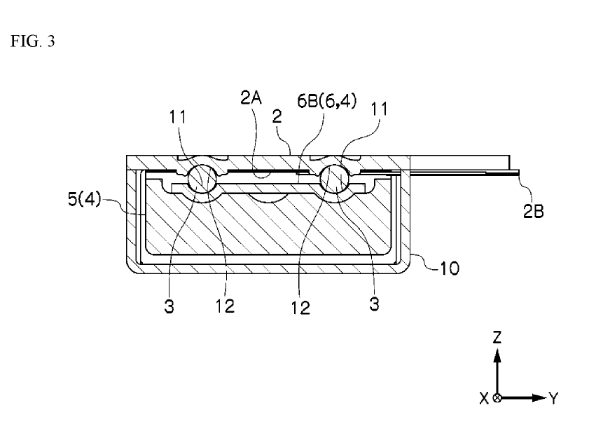

As illustrated in FIG. 1 (an exploded perspective diagram), FIG. 2 (wherein (a) is a plan view and (b) is a cross-sectional view along the section A-A), and FIG. 3 (which is a cross-sectional view along the section B-B in FIG. 2 (a)), the vibration actuator 1 according to the embodiment according to the present invention comprises a plate-shaped body 2, a movable element 4, elastic members 7, a coil 8, and a frame 10.

The plate-shaped body 2 structures a top cover in a frame 10 of a nonmagnetic body wherein the top is open, and is made from a magnetic material that has a flat supporting surface 2A. The movable element 4 is provided with a weight 5, a magnet 9, and a connecting body 6 for connecting therebetween, and is in partial contact, through contact pieces 3 at a plurality of locations (preferably three locations) of the supporting surface 2A in the plate-shaped body 2. While in the example in the figure an example is depicted wherein the plate-shaped body 2 and the movable element 4 are in partial contact through the contact pieces 3, instead protruding portions that protrude in the Z axial direction may be provided on the plate-shaped body 2 side or the movable element 4 side, and these may be brought into partial contact directly.

Preferably the contact pieces 3 are rolling elements that make rolling contact with the plate-shaped body 2 side and the movable element 4 side. As illustrated, the rolling elements may be spherical bodies that make point contacts with the plate-shaped body 2 side and the movable element 4 side, or may be cylindrical bodies (rollers) that make linear contact with the plate-shaped body 2 side and the movable element 4 side.

The movable element 4 vibrates in the axial direction (the X axial direction in the figure) along the supporting surface 2A, while maintaining partial contact with the plate-shaped body 2. Guiding grooves 11 that hold the contact pieces 3 are provided on the movable element 4 side, where these guiding groove 11 extend along the direction of vibration (the X axial direction in the figure) of the movable element 4. In the example in the figures, an example is depicted wherein the guiding grooves 11 are provided on the movable element 4 side, and holding grooves 12 for holding the contact pieces 3 are provided on the plate-shaped body 2 side; however, the guiding grooves 11 may instead be provided on the plate-shaped body 2 side with the holding grooves 12 on the movable element 4 side, or guiding grooves 11 may be provided on both the plate-shaped body 2 side and the movable element 4 side.

In the coil 8 for driving the movable element 4, a coil part 8A is disposed perpendicular in respect to the axial direction (the X axial direction in the figure) in a space between the movable element 4 and the plate-shaped body 2, and is secured in relation to the plate-shaped body 2. In the example in the figure, the coil 8 is wound in a flat shape in a gap between the magnet 9 and the plate-shaped body 2. The aforementioned coil part 8A regulates the direction of the current that produces the Lorentz forces for causing the movable element 4 to vibrate in the X axial direction, and insofar as such a coil part 8A is formed, how the coil 8 itself is wound is not limited to the example in the figures.

The magnet 9 that is equipped in the movable element 4 produces the magnetic flux that passes through the coil part 8A of the coil 8, described above, between the plate-shaped body 2 that is of a magnetic material (a yoke), and has a function for producing magnetic attraction of the movable element 4 toward the supporting surface 2A side of the plate-shaped body 2. In the example in the figures, the magnet 9 comprises a pair of magnet pieces 9A and 9B that have mutually opposing directions of magnetization in the direction that is perpendicular to the supporting surface 2A (the Z axial direction in the figure), where these magnet pieces 9A and 9B are disposed facing the coil part 8A of the coil 8, so as to form magnetic flux that passes through the coil part 8A in the Z axial direction. Moreover, having the frame 10 be a nonmagnetic body increases the force of magnetic attraction between the magnet 9 and the plate-shaped body 2, which is made from a magnetic material.

The weights 5 that are provided in the movable element 4 are disposed in a pair along the axial direction (the X axial direction in the figure), with the magnet 9 held therebetween. Through this, in the movable element 4, the pair of weights 5 and the magnet 9 that is disposed therebetween, are laid out in a row along the axial direction (the X axial direction in the figure). The connecting body 6 that connects these weights 5 and the magnet 9 into a single unit is a bent plate-shaped member comprising a magnetic supporting portion 6A for supporting the bottom face side (the side that is opposite from the side that faces the plate-shaped body 2) of the magnet 9, and weight supporting portions 6B for supporting the top face sides (the sides that face the plate-shaped body 2) of the weights 5. The magnet 9, the weights 5, and the connecting body 6 are joined together through adhesive bonding, welding, or the like. Note that, if necessary, the magnetic supporting portion 6A is provided with a reinforcing portion 6A1 that is bent in the Z axial direction.

Guiding grooves 11 for holding the contact pieces 3 on the connecting body 6 may be provided in the weight supporting portion 6B of the connecting body 6. The provision of the guiding grooves 11 in the connecting body 6 in this way makes it possible to select the material for the connecting body 6 to reduce the contact resistance with the contact pieces 3 within the guiding groove 11.

Moreover, the connecting body 6 is a magnetic member, where a magnetic circuit is structured from the magnet 9 and the plate-shaped body 2. At this time, the weight supporting portions 6B, wherein are formed the guiding grooves 11 for holding the contact pieces 3, will be in a state that is adjacent to the plate-shaped body 2 with a contact piece 3 therebetween, and thus the magnetic attraction between the weight supporting portion 6B and the plate-shaped body 2 is increased, enabling an increase in magnetic attraction on the movable element 4 toward the plate-shaped body 2 side in a state wherein the contact pieces 3 are held reliably between the guiding grooves 11 and the holding grooves 12.

The elastic members 7 are springs (for example, coil springs) for elastically repelling the vibration along the axial direction of the movable element 4, and are supported within the frame 10. One end side of the elastic member 7 is supported on an end face of the weight 5, and the other end side of the elastic member 7 is supported on a supporting portion 10A that is provided on the frame 10.

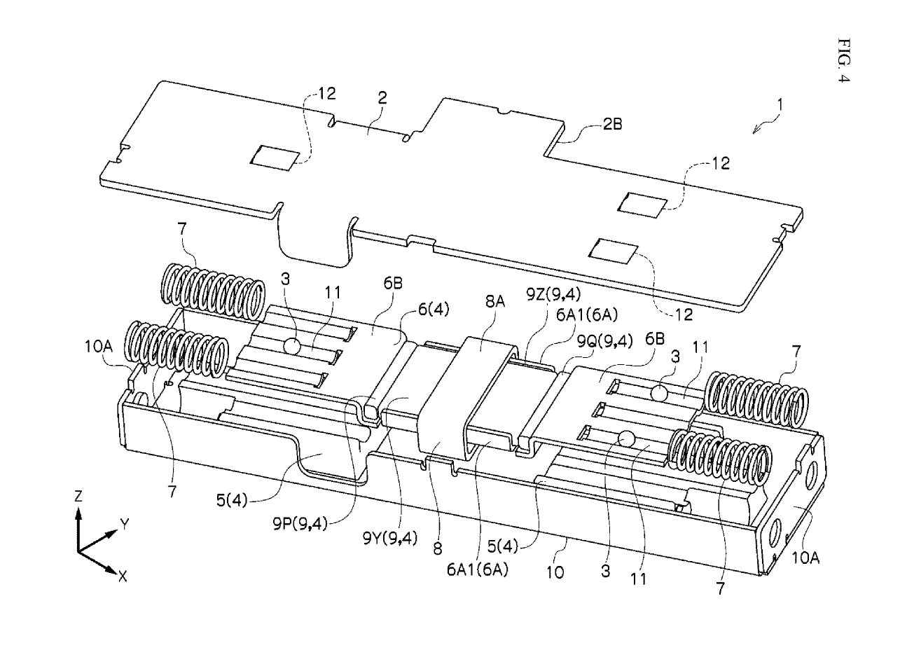

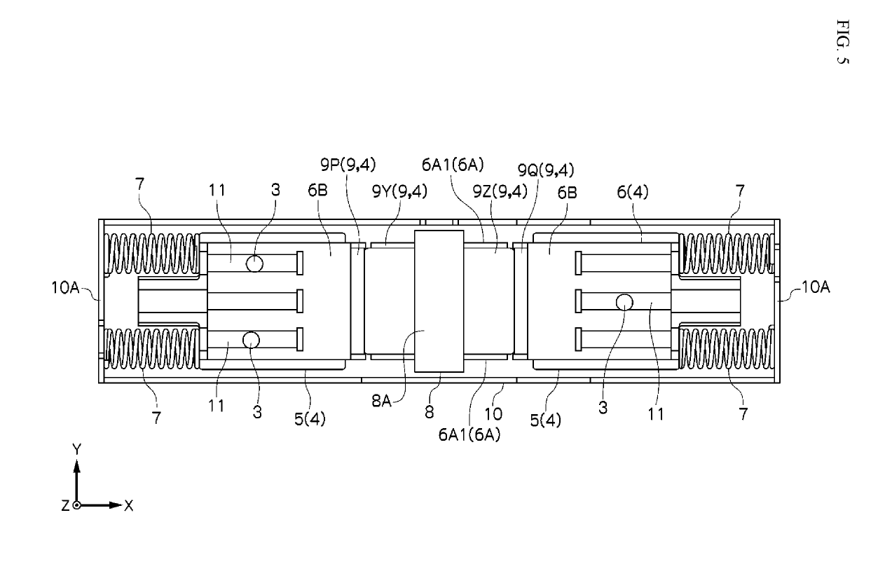

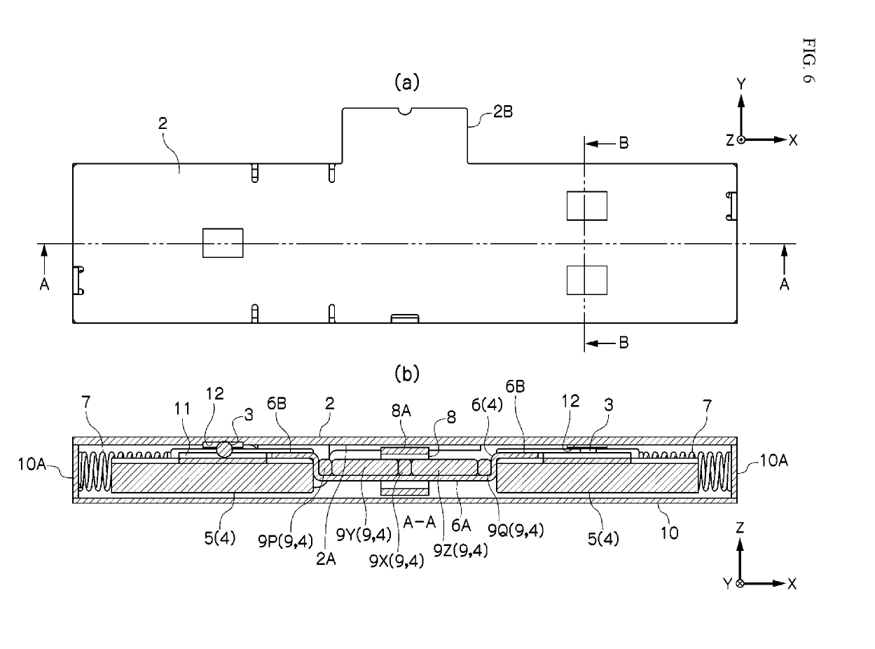

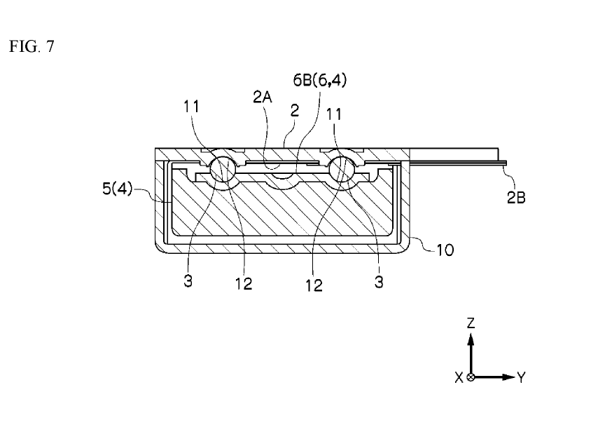

FIG. 4 through FIG. 7 illustrate an example of another shape for the vibration actuator 1 according to an embodiment according to the present invention. In this example, the coil 8 is wound around the magnet 9, but the coil part 8A, described above, need only regulate the direction of the current that produces the Lorentz forces in order to cause the movable element 4 to vibrate in the X axial direction, and the way in which the coil 8 itself is wound is not limited to that of the example in the figure.

In the example in the figure, the plate-shaped body 2 structures a top cover in the frame 10, wherein the top is open, and is made from a magnetic member that has a flat supporting surface 2A. The movable element 4 is provided with a weight 5, a magnet 9, and a connecting body 6 for connecting therebetween, and is in partial contact, through contact pieces 3 at a plurality of locations (preferably three locations) of the supporting surface 2A in the plate-shaped body 2. While in the example in the figure an example is depicted wherein the plate-shaped body 2 and the movable element 4 are in partial contact through the contact pieces 3, instead protruding portions that protrude in the Z axial direction may be provided on the plate-shaped body 2 side or the movable element 4 side, and these may be brought into partial contact directly. Note that, in this example, the frame 10 may either be magnetic or nonmagnetic.

In this example, the magnet 9 that is provided in the movable element 4 is structured from a magnet piece 9X that is disposed facing the coil part 8A of the coil 8, and other magnet pieces 9Y, 9Z, 9P, and 9Q. Here either of the magnet pieces 9A or 9Z, and the magnet pieces 9P and 9Q, may be omitted. In this magnet 9, the magnet pieces 9X has a direction of magnetization toward the plate-shaped body 2, perpendicular to the supporting surface 2A. Moreover, the magnet pieces 9Y and 9Z have directions of magnetization that are mutually opposing along the X axial direction, and that face the magnet piece 9X. The magnet pieces 9P and 9Q have directions of magnetization that are perpendicular to the supporting surface 2A, and are in the opposite direction from the plate-shaped body 2.

The arrangement of the magnet pieces 9X through 9Q in the magnet 9 is called a Halbach array, and forms a magnetic field that has magnetic flux that passes through the coil part 8A of the coil 8, from the magnet piece 9X, in the direction of the plate-shaped body 2 that is a magnetic member (a yoke), and that is also deflected toward the supporting surface 2A side of the plate-shaped body 2. In this way, the various magnet pieces mutually cooperate so that the magnet 9 forms a magnetic field that is deflected toward the supporting surface 2A, so that the movable element 4 wherein the magnet 9 is provided will be attracted magnetically to the plate-shaped body 2, which is a magnetic member. The connecting body 6 that connects together the weights 5 and the magnet 9 preferably is a nonmagnetic body here.

The vibration actuator 1 that is illustrated in FIG. 1 through FIG. 7 is driven by Lorentz forces that act on the magnet 9 through application of an electric current to the coil 8, to undergo linear reciprocating vibration along the axial direction (the X axial direction in the figure). At this time, the flat movable element 4 will vibrate along the supporting surface 2A while maintaining a state of partial contact at a plurality of locations (preferably, three locations) with the flat supporting surface 2A in the plate-shaped body 2, due to the magnetic attraction between the plate-shaped body 2 and the magnet 9. This suppresses rolling of the flat movable element 4 around the axes of vibration, enabling a stable linear vibration.

Moreover, forming the plane of the supporting surface 2A of the plate-shaped body 2 accurately eliminates the need for high-accuracy assembly operations when assembling the vibration actuator 1. Moreover, the guide shafts are eliminated, which can also reduce the number of components. This enables an improvement in the ease of operations during assembly.

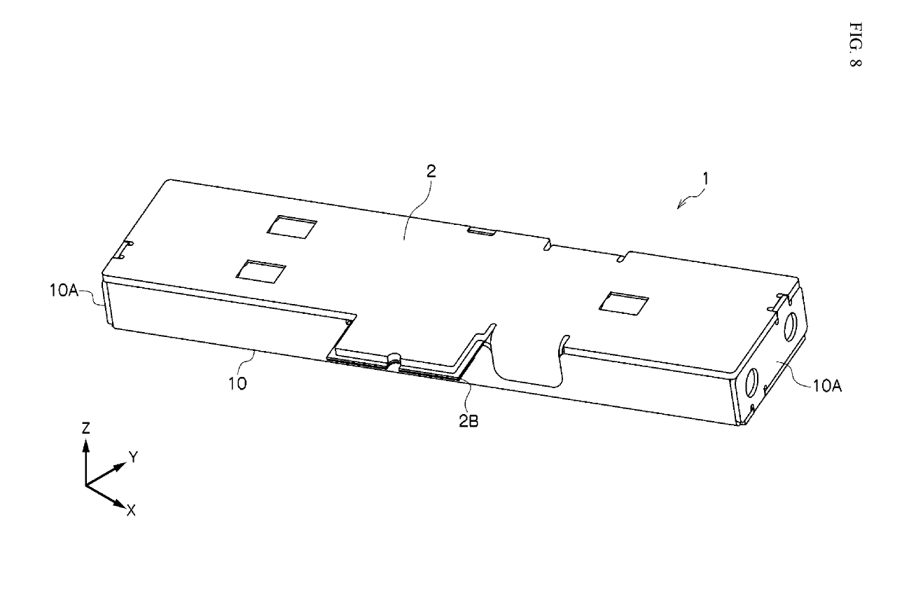

FIG. 8 depicts an assembled vibration actuator. In the vibration actuator 1, the plate-shaped body 2 is a top cover that covers one surface side of the movable element 4, where the other surface side is provided with a case structure that is covered by the frame 10. In the plate-shaped body 2, a signal input terminal portion 2B, to which the terminal of the coil 8 is connected, is formed so as to protrude on a side portion.

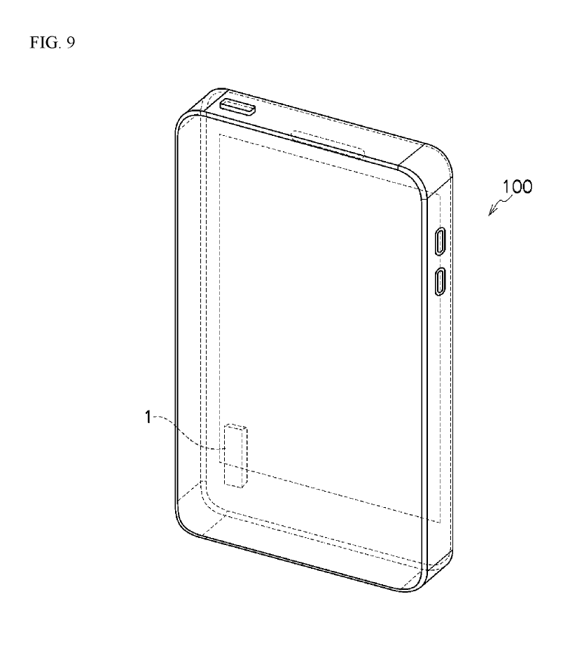

FIG. 9 depicts a mobile information terminal 100 as an example of a mobile electronic device that is provided with a vibration actuator 1 according to an embodiment according to the present invention. The mobile information terminal 100 that is provided with the vibration actuator 1 that can produce a stabilized vibration and that can have reduced thickness and reduced size in the width direction can notify the user through a stabilized vibration, which tends not to produce noise, at the beginnings and ends of operations such as incoming calls in a communication function, alarm functions, and the like. Moreover, this makes it possible to produce a mobile information terminal 100 that facilitates superior mobility and design quality through making the linear vibration motor 1 thinner as well as smaller in the width direction. Moreover, because the vibration actuator 1 is of a compact shape wherein each of the portions is contained within a case of a box shape wherein the thickness has been constrained, the vibration actuator 1 can be installed in a thinner mobile information terminal 100, with good spatial efficiency.

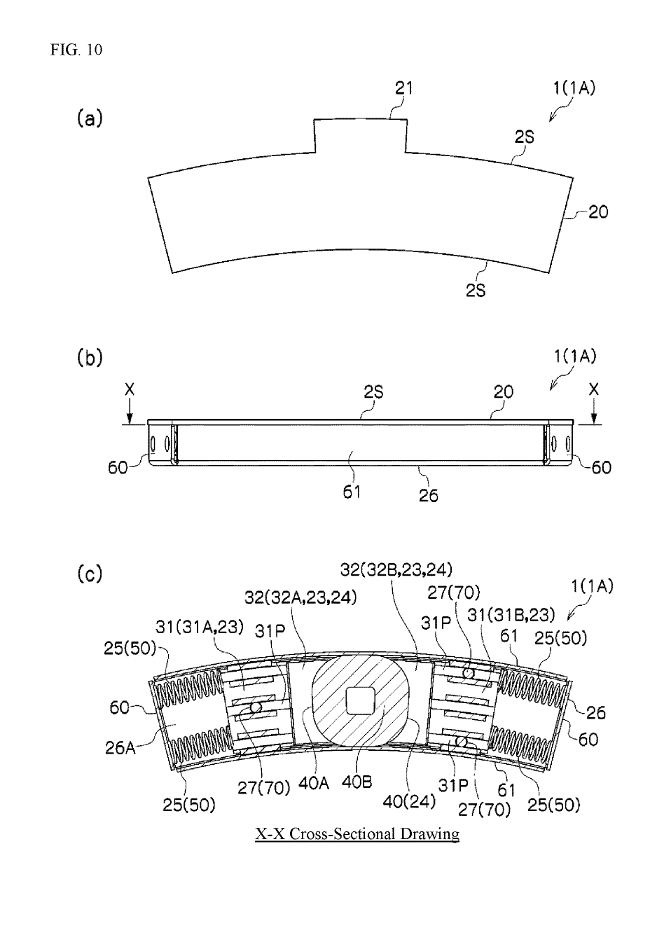

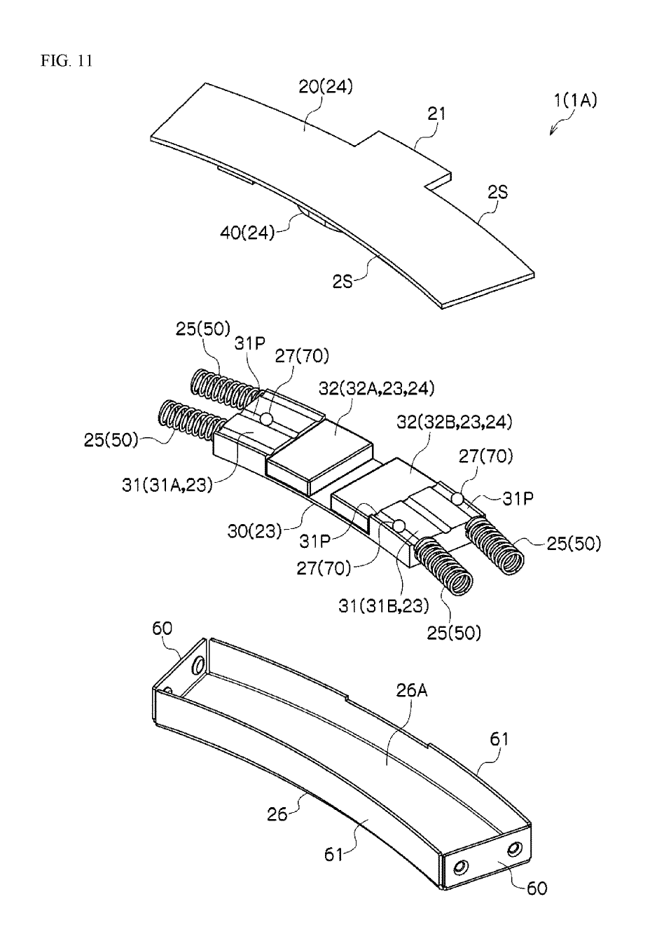

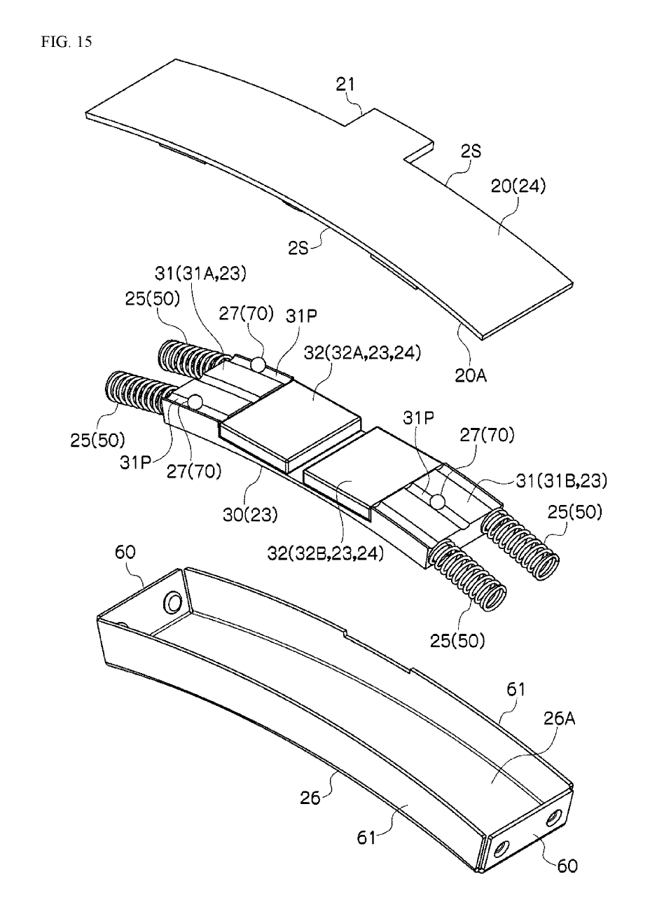

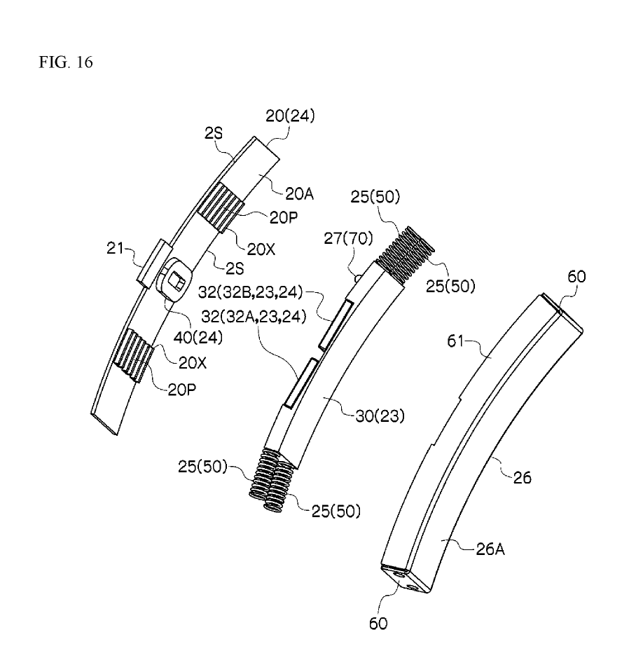

Another embodiment according the present invention will be explained below in reference to FIG. 10 through FIG. 18. The vibration actuator (1A) comprises a supporting plate 20, a movable element 23, a driving portion 24, and elastic members 25. In each of the figures, identical reference codes are assigned to identical locations, and redundant explanations for each of the figures are omitted.

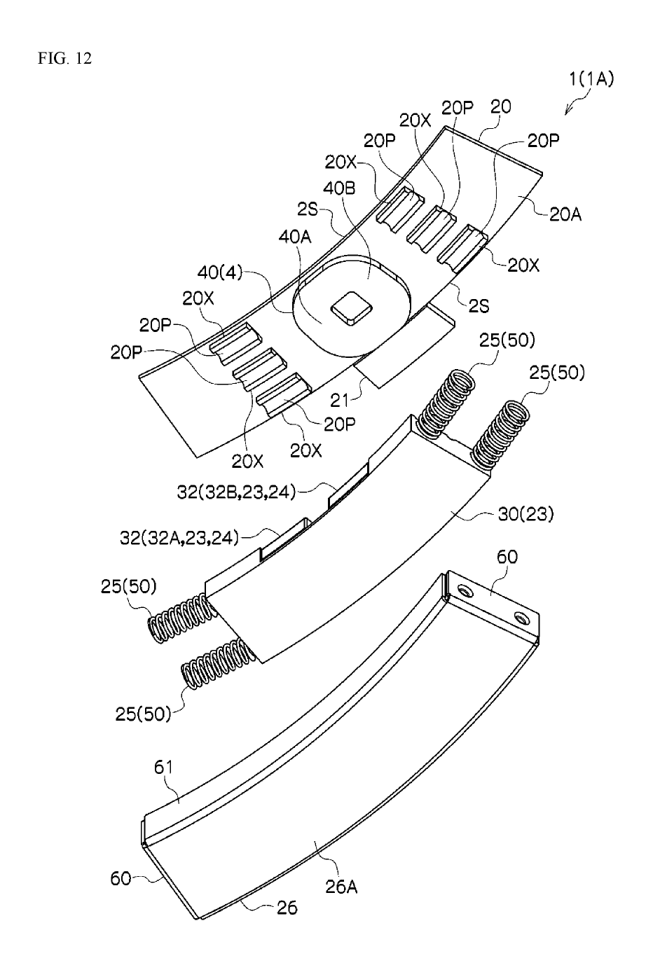

The supporting plate 20 has a guiding portion 20X (referencing FIG. 12) that has one edge 2S, on the outer shape, that is curved, and a vibration track along the outer shape edge 2S on the inner surface 20A. In this example, the inner surface 20A is flat, and a pair of outer shape edges 2S are arranged along the inner surface 20A, parallel to each other. Moreover, the supporting plate 20 is a plate-shaped body that is formed from a magnetic material, and serves as a yoke for forming a magnetic circuit for the driving portion 24, described below. On this supporting plate 20, an input terminal portion 21 of the driving portion 24 is provided so as to protrude from an outer shape edge 2S.

The movable element 23, through being biased toward the inner surface 20A of the supporting plate 20, is guided on the guiding portions 20X that are provided on the inner surface 20A of the supporting plate 20, so as to vibrate reciprocatingly along the vibration track. In the movable element 23, a weight 31 and a magnet 32 are provided integrally on a movable frame 30, where, in the example in the figure, the weight 31 comprises a pair of weights 31A and 31B, and the magnet 32 comprises a pair of magnets 32A and 32B.

The driving portion 24 causes the movable element 23 to undergo reciprocating vibration along the inner surface 20A of the supporting plate 20, and here is structured from a coil 40 that is secured to the inner surface 20A of the supporting plate 20, the magnet 32 (32A and 32B) that is attached to the movable element 23 so as to face the coil 40, and a supporting plate 20 made from a magnetic material that serves as a yoke, as described above.

Here the coil 40 is wound along the inner surface 20A of the supporting plate 20, and comprises a pair of coil parts 40A and 40B that is perpendicular to the direction of vibration of the movable element 23, where the coil part 40A faces the magnet 32A, and the coil part 40B faces the magnet 32B. The magnets 32A and 32B have magnetic poles in mutually opposing directions in directions that are perpendicular to the inner surface 20A, so as to form lines of magnetic flux that pass through the coil parts 40A and 40B of the coil 40.

The elastic members 25 support elastically the reciprocating vibration of the movable element 23, and, in the example in the figure, comprise coil springs 50 that have compressive and tensile elasticity in the direction along the vibration track These elastic members 25 (coil springs 50) are each supported on one end by the weight 31 (31A or 31B), and supported on the other end on the inner surface side of the supporting side face 60 of the frame 26, and are arranged in pairs, along the direction of vibration, and pairs in the direction that is perpendicular to the direction of vibration, with a total of four elastic members 25 disposed within the frame 26.

The frame 26 is installed on the supporting plate 20 so as to surround the movable element 23, and comprises a bottom face 26A that faces the inner surface 20A of the supporting plate 20, supporting side faces 60 that are perpendicular to the inner surface 20A of the supporting plate 20 and perpendicular to the track of vibration, and which support the elastic members 25, as described above, and side faces 61 along the outer shape edges 2S of the supporting plate 20, perpendicular to the inner surface 20A of the supporting plate 20.

Here spacers 27, for maintaining a constant space between the movable element 23 and the inner surface 20A of the supporting plate 20 are disposed on the guiding portions 20X of the supporting plate 20. In the example in the figure, the spacers 27 are rolling elements 70, where the guiding portions 20X are provided with groove portions 20P for holding the rolling elements 70. Groove portions 31P for holding rolling element 70 are also provided in the weights 31 (31A and 31B) of the movable element 23. While here the rolling elements 70 are depicted as an example of the spacers 27, there is no limitation thereto, but rather the spacers 27 may be, for example, protruding portions that protrude from the movable element 23 side.

The operation of the vibration actuator 1 (1A) will be explained. Through applying a driving signal to the coil 40 that is secured to the supporting plate 20, the Lorentz forces that act on the magnet 32 that is provided in the movable element 23 act as a driving force to cause the movable element 23 to undergo reciprocating vibration along the guiding portions 20X. At this time, the magnet 32, which is provided on the movable element 23, and the supporting plate 20, which is a magnetic member, are drawn toward each other through magnetic attraction, and in a state wherein the movable element 23 is biased toward the inner surface 20A of the supporting plate 20, a constant spacing between the movable element 23 and the inner surface 20A of the supporting plate 20 is maintained by the existence of the spacers 27.

Given this, the movement of the movable element 23 is movement along the track of vibration of the guiding portions 20X, through the movable element 23 being biased toward the inner surface 20A of the supporting plate 20, so that the movable element 23 undergoes reciprocating vibration along the curved outer shape edges 2S of the supporting plate 20. In the example in the figure, the movable element 23 is supported on the guiding portions 20X, which are provided on the inner surface 20A, supported at three locations by the spacers 27 (rolling elements 70). Through this, the movable element 23, which is biased toward the inner surface 20A side, will always vibrate within a plane that is parallel to the inner surface 20A, thus achieving stabilized reciprocating vibration. Here there is no need for the guiding portions 20X to form a vibration track that is curved similarly to the outer shape edges 2S, but rather it may have a pair of straight tracks that are inclined along the curve of the outer shape edge 2S.

The provision, on the supporting plate 20, of the supporting side faces 60 that are provided in the frame 26 enables either elimination of the frame 26 itself, or enables a structure wherein the structure that surrounds the movable element 23, like the frame 26, has a portion thereof structured from the case of the electronic device in which the vibration actuator 1 (1A) is installed. When a frame 26 (or a portion of the case corresponding thereto) is provided, this can constrain the movable element 23 in the event that the magnetic attraction between the supporting plate 20 and the movable element 23 is disrupted through the effects of a mechanical shock on the vibration actuator 1 (1A), to enable the magnetic attraction between the supporting plate 20 and the movable element 23 to be reestablished. In this case, setting the height of the side faces 61 of the frame 26 to be a dimension wherein the spacers 27 will not come out of the guiding portions 20X, even if the supporting plate 20 and the movable element 23 were to temporarily come apart, enables automatic and reliable recovery.

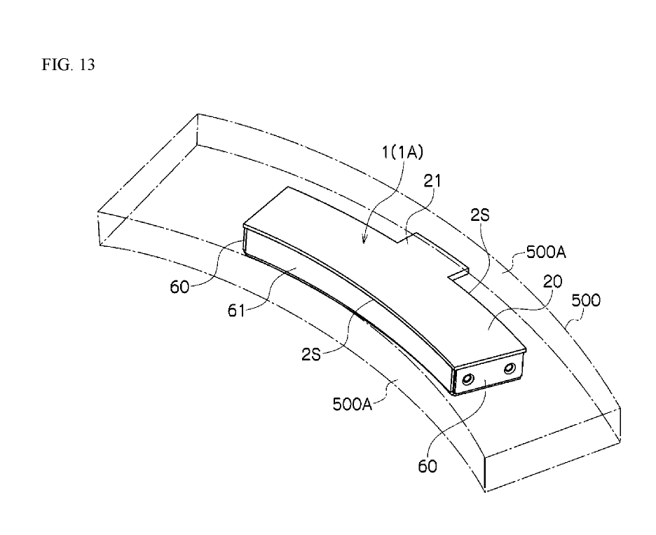

The vibration actuator 1 (1A) of this type, as illustrated in FIG. 13, has an outer shape that is curved along the outer shape edge 2S of the supporting plate 20. This enables the vibration actuator 1 (1A) to be equipped with good spatial efficiency (with little dead space) through the provision of the outer shape edge 2S of the supporting plate 20 along the curve if the case 500 of the electronic device wherein the vibration actuator 1 (1A) is installed has a sidewall 500A that has a curve.

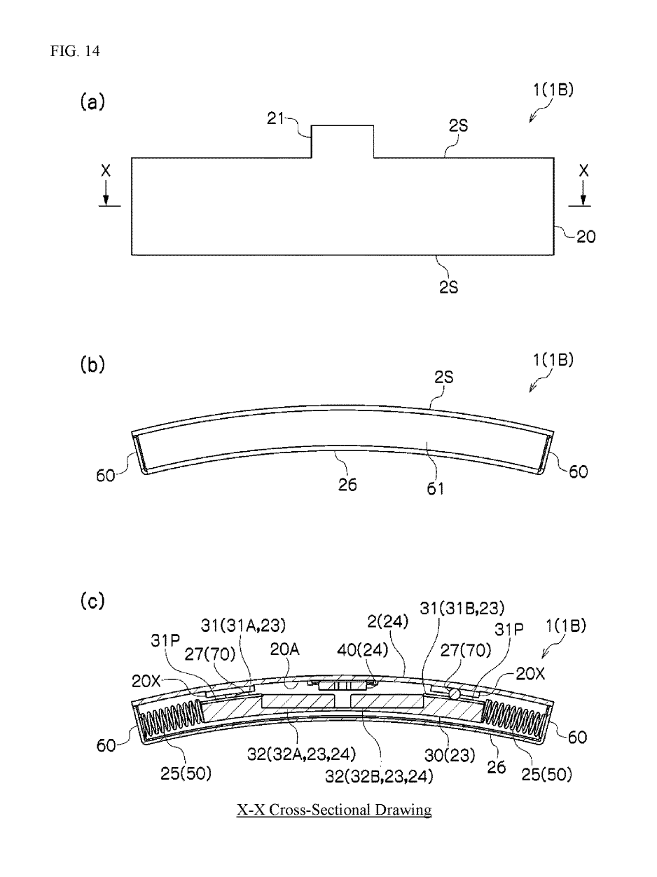

FIG. 14 through FIG. 17 depict a vibration actuator according to another embodiment according to the present invention. This vibration actuator 1 (1B), as with the embodiment in FIG. 10 through FIG. 18, described above, comprises a supporting plate 20, a movable element 23, a driving portion 24, and elastic members 25, and is provided with the identical structure, with the exception of a different curved shape in the supporting plate 20. Consequently, in each of the figures, reference codes are assigned that are the same as those that have been explained before, and redundant explanations for each of the figures are omitted.

In the vibration actuator 1 (1B) as set forth in this other embodiment, the inner surface 20A of the supporting plate 20 has a curved surface shape, where a pair of curved outer shape edges 2S are disposed parallel to each other along the inner surface 20A of the supporting plate 20. In this vibration actuator 1 (1B), the movable element 23 can be vibrated reciprocatingly along a track of vibration that follows the inner surface 20A of the curved supporting plate 20.

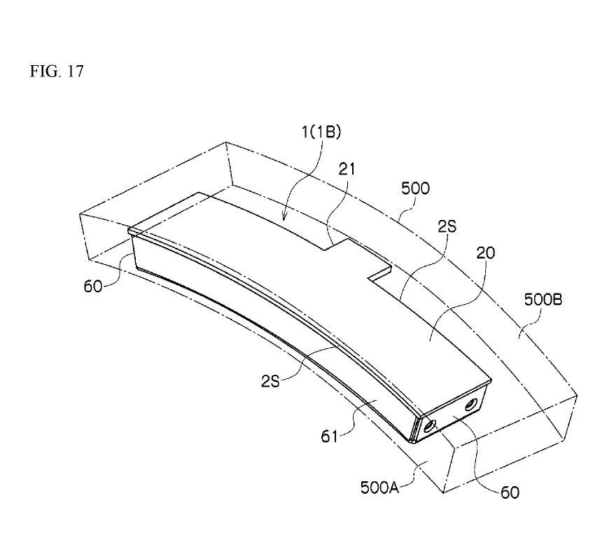

In this way, the vibration actuator 1 (1B), as illustrated in FIG. 17, has an outer shape that is curved along the inner surface 20A of the supporting plate 20. Given this, even if the case 500 of the electronic device wherein the vibration actuator 1 (1B) is equipped has a curved top wall or bottom wall 500B, the inner surface 20A of the supporting plate 20 is disposed along this curve, enabling installation of the vibration actuator 1 (1B) with good spatial efficiency (little dead space).

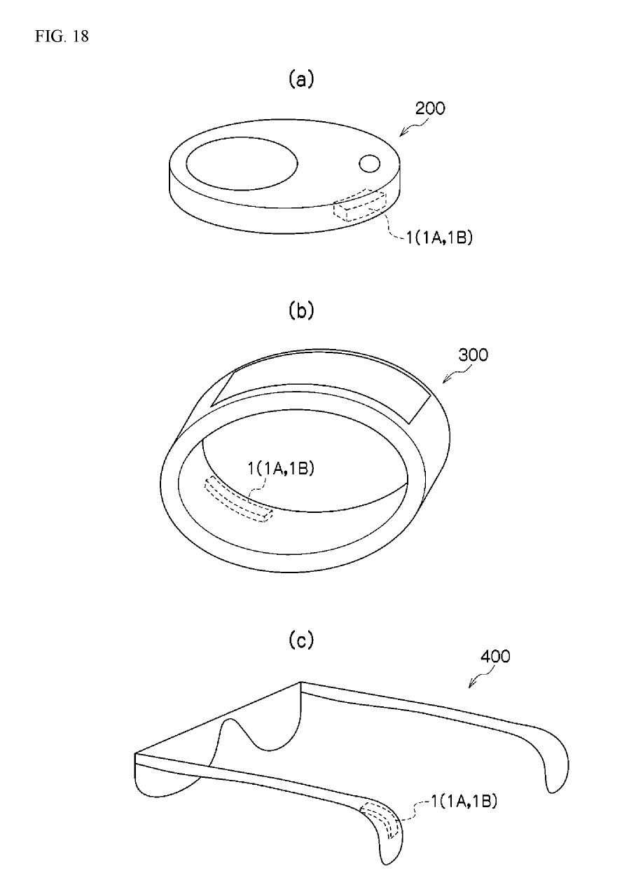

FIG. 18 illustrates an example of an electronic device that is equipped with a vibration actuator 1 (1A or 1B) as described above. FIG. 18 (a) shows a disk-shaped mobile electronic device 200; FIG. 18 (b) shows a wearable electronic device 300 of a wristband type; and FIG. 18 (c) shows a wearable electronic device 400 of an eyeglass type. In all of these examples, the outer shape edge 2S of the supporting plate 20 has a shape that curves along the curved part of the case, enabling installation into the device with good spatial efficiency, where the disposal of the vibration actuator 1 (1A or 1B) near to the skin, or the like, of the user enables the information to be relayed effectively, via the vibration, to the user of the device.

While embodiments according to the present invention were described in detail above, referencing the drawings, the specific structures thereof are not limited to these embodiments, but rather design variations within a range that does not deviate from the spirit and intent of the present invention are also included in the present invention.

1. A vibration actuator, comprising:
a plate-shaped body made from a magnetic material that has a flat supporting surface;
a movable element that is in partial contact, either directly or through a contact piece, in a plurality of locations of the supporting surface, and that vibrates in an axial direction along the supporting surface;
an elastic member elastically repelling the vibration of the movable element; and
a coil secured to the plate-shaped body, and wherein a coil part that is perpendicular to the axial direction is disposed in a space between the movable element and the plate-shaped body, wherein:
the movable element comprises a magnet that forms a magnetic flux that passes through the coil part of the coil, between the movable element and the plate-shaped body, and that magnetically attracts the movable element toward the supporting surface side.

2. The vibration actuator as set forth in claim 1, wherein:
the magnet comprises a pair of magnet pieces having directions of magnetization that are mutually opposing, in a direction that is perpendicular to the supporting surface, wherein:
the coil is wound in a flat shape in a gap between the magnet and the plate-shaped body.

3. A vibration actuator comprising:
a plate-shaped body made from a magnetic material that has a flat supporting surface;
a movable element that is in partial contact, either directly or through a contact piece, in a plurality of locations of the supporting surface, and that vibrates in an axial direction along the supporting surface;
an elastic member elastically repelling the vibration of the movable element; and
a coil secured to the plate-shaped body, and wherein a coil part that is perpendicular to the axial direction is disposed in a space between the movable element and the plate-shaped body, wherein:
the movable element comprises a magnet; and
the magnet is disposed facing a coil part of the coil, and comprisies one magnet piece that has a direction of magnetization that is perpendicular to the supporting surface, and another magnet piece that forms a magnetic field that is deflected to the supporting surface side.

4. The vibration actuator as set forth in claim 3, wherein:
the coil is wound around the periphery of the magnet.

5. The vibration actuator as set forth in claim 1, wherein:
the movable element comprises a pair of weights that are arranged along the axial direction with the magnet held therebetween, and a connecting body for connecting the magnet and the weights together as a single unit.

6. The vibration actuator as set forth in claim 1, wherein:
the movable element comprises a pair of weights that are arranged along the axial direction with the magnet held therebetween, and a connecting body for connecting the magnet and the weights together as a single unit; and
the connecting body is made from a magnetic material.

7. The vibration actuator as set forth in claim 5, wherein:
the movable element makes partial contact with the supporting surface through a contact piece; and
the contact piece is held on the connecting body.

8. The vibration actuator as set forth in claim 7, wherein:
the contact is a rolling element, and makes either point contact or line contact on the plate-shaped body side and the movable element side.

9. The vibration actuator as set forth in claim 1, wherein:
the plate-shaped body covers one surface side of the movable element, where the other surface side of the movable element is covered by a frame, and the elastic member is supported within the frame.

10. The vibration actuator as set forth in claim 1, wherein:
the plate-shaped body covers one surface side of the movable element, where the other surface side of the movable element is covered by a frame of a nonmagnetic body, and the elastic member is supported within the frame.

11. A mobile electronic device comprising a vibration actuator as set forth in claim 1.

12. A vibration actuator, comprising:
a supporting plate comprising an outer shape edge that is curved, and a guiding portion, in an inner surface, that has a vibration track along the outer shape edge;
a movable element that undergoes reciprocating vibration along the vibration track, guided by the guiding portion, through being biased toward the inner surface side;
a driving portion causing the movable element to undergo reciprocating vibration along the inner surface; and
an elastic member supporting elastically the reciprocating vibration of the movable element.

13. The vibration actuator as set forth in claim 12, wherein:
the driving portion comprises a coil that is secured to an inner surface of the supporting plate, and a magnet that is attached to the movable element, facing the coil; and
the movable element is biased toward the inner surface through magnetic attraction between the magnet and the supporting plate that is made from a magnetic material.

14. The vibration actuator as set forth in claim 13, wherein:
a spacer maintaining a constant spacing between the inner surface and the movable element is disposed in the guiding portion.

15. The vibration actuator as set forth in claim 14, wherein:
the spacer is a rolling element and the guiding portion and the movable element have groove portions for holding the rolling element.

16. The vibration actuator as set forth in claim 12, wherein:
the inner surface is planar, and the pair of outer shape edges are disposed along the inner surface so as to be mutually parallel.

17. The vibration actuator as set forth in claim 12, wherein:
the inner surface is a curved surface, and the pair of outer shape edges are disposed along the inner surface so as to be mutually parallel.

18. The vibration actuator as set forth in claim 12, further comprising:
a frame equipped with a bottom face that faces the inner surface, a supporting side face, perpendicular to the inner surface and to the vibration track, supporting the elastic member, and a side face that is perpendicular to the inner surface and that follows the outer shape edge.

19. A mobile electronic device, comprising:
a vibration actuator as set forth in claim 12, and having an outer shape that follows the outer shape edge.

20. A wearable electronic device, comprising:
a vibration actuator as set forth in claim 12, and having an outer shape that follows the outer shape edge.
